(19) United States
(12) Patent Application Publication
(10) Pub. No.: US 2007/0090185 A1
(43) Pub. Date: Apr. 26, 2007

(54) Device and method for shopping and data collection

(75) Inventors: Michael Alexander Baldwin Lewkowitz, London (CA); Peter Day, Oakville (CA)

Correspondence Address: SMART AND BIGGAR, 438 UNIVERSITY AVENUE, SUITE 1500 BOX 111, TORONTO, ON, M5G2K8, CA

(73) Assignee: Clean Energy Developments Corp.

(21) Appl. No.: 11/257,030

(22) Filed: Oct. 25, 2005

(51) Int. Cl. G06K 15/00; G06K 7/10

(52) U.S. Cl. 235/383; 235/462.46

(57) ABSTRACT

A device and method of presenting information about goods and services to a targeted audience is disclosed. The disclosed device and method allow collecting associated marketing data. An exemplary handheld device equipped with a tag reader is described. The device and method are well suited for showrooms used by builders of homes, appliance vendors and the like. The marketing information, which is accessible by way of a communications network in an aggregated form, can greatly enhance the shopping experience for consumers, and improve marketing efficiency of builders, retailers and sellers.

### FIELD OF THE INVENTION

The present invention relates generally to a computing device and method for marketing, and more particularly to a handheld computing device for use at a point of sale and associated hardware and software.

### BACKGROUND OF THE INVENTION

Shopping for large purchases such as a new home or big-ticket items can often be a frustrating and cumbersome experience. Consumers have a number of options that they must weigh carefully in the context of an array of perceptions, motivations, and interests. As these purchase decisions are typically made as a family, the family must form a consensus before proceeding to buy. Consumers therefore make their decision slowly. Moreover, demand here is more differentiated and less responsive to prices than in mass markets for cheaper commodities. Thus, marketing and sales strategies that may work well for commodity markets tend to be ineffective and inefficient for big-ticket items.

The real estate market for instance, usually suffers from inefficiencies in aligning demand with available supply. Typically, prospects walk into a showroom where model homes are displayed, often complete with major appliances and fixtures, and attempt to decide on whether a displayed model home or some close variation of it matches their desires, needs and budget. They may talk to a salesperson in the showroom, if one is available, and ask questions to get relevant details. The salesperson, in turn, may ask questions of the prospects to gain valuable insights about their needs for any future follow up. Similar interactions between customers and salespeople can be observed in high-end home entertainment system showrooms, large appliance stores and even car dealerships. However, this traditional approach has many shortcomings.

To start with, it is difficult to put on display all available variations of the product in a showroom. For home builders for instance, it is not feasible to show all models of fixtures, various sizes of and colors of appliances, and textures of finishing material on various items, as showroom real estate itself is a limited resource. Builders and vendors may make use of brochures, glossy posters and booklets to show the various options available, but brochures and posters are often not dynamic enough to be very effective and require a certain degree of imagination on the part of the prospective clients to visualize the end result.

Suppliers usually display just one sample of a fixture, one type of finishing and one wall color in their showrooms and must rely on salespersons to show prospects the various alternatives available that may not be apparent from the display. The effectiveness of the presentation thus depends to some degree on the talents of the individual salesperson. Important selling features may not be effectively communicated to the prospects if for instance, the salesperson fails to point them out.

Sales and marketing efforts that rely exclusively on salespeople are inherently labor intensive and therefore expensive. Moreover, when two or more groups of prospective clients visit a showroom, salespersons may not always be around or may otherwise be occupied with other prospective clients. Prospective clients who are often couples or families may also want to have the option of browsing the showroom on their own, freely discussing the merits or demerits of what they see in relative privacy, and still be able to obtain explanatory information on particular fixtures.

The salesperson must often ask questions to gauge how important a given fixture is, to the prospective client. However, some clients may find a salesperson's inquiry about their needs and budget too intrusive. Moreover, a salesperson is unlikely to know about all the details of a particular feature in the product. Sophisticated clients may inquire about detailed technical issues that would challenge all but the most knowledgeable and experienced salespersons. It would therefore be useful to have material for the prospects that is detailed, well organized for presentation and prepared in advance.

A further disadvantage associated with current marketing functions in showrooms is that, builders and vendors of major appliances do not fully capitalize on very useful marketing data that prospective customers are willing to share regarding their needs. The salesperson they deal with is often not able to retain all the relevant marketing information that would be crucial in any follow-up marketing. The salesperson may often fail to ask questions that the prospective clients are willing to answer, may not remember all the answers; or may ask questions that make them uncomfortable.

In addition, since large purchases like that of a home are among the most important financial decisions that families make, the commitment to purchase is unlikely to be made quickly or with a single visit to a showroom. Prospects are apt to visit many showrooms, often operated by different builders and vendors, and will vacillate for a while before they commit to a particular house or condominium or a major appliance. Thus, even if the problems discussed earlier could be overcome and good marketing data could be collected efficiently in a given showroom, information gleaned from one particular visit would be incomplete and fragmented. Data gathered regarding a given prospect in various showrooms will likely be stored disparately, without any cross-references to data from other showrooms that the same prospect visits. Typically, interactions of marketers with prospects at this stage do not allow marketers to gather data that truly reflect the needs of prospects in a real context. Therefore such data gives only a partial picture and is unlikely to be very effective as a marketing aid.

There is therefore, accordingly a need to enhance the shopping experience for major purchases and to increase the effectiveness of the marketing effort on the part of builders, suppliers and vendors.

### SUMMARY OF THE INVENTION

The present invention addresses some of these shortcomings with the use of computing hardware and software including a convenient handheld device for displaying product information and collection of prospect data.

In accordance with an aspect of the present invention, there is provided a handheld device that can be used to read product identification tags affixed in showrooms, on or near fixtures, appliances, and other goods, and display the product information associated with the tag. The handheld device includes a processor, memory, display, a tag-reader device and software. The handheld device is operable to communicate with a communications network to upload collected data associated with a prospect. The uploaded data reflects the preferences and interests of a prospect in products about which product information was presented on the handheld device.

In accordance with another aspect of the present invention, there is provided a central server, accessible by computing devices via a communications network. The server is equipped with software that enables a valid user to access, view, modify, download or upload data. In particular, information collected using handheld devices from several showroom locations is uploaded to the central server.

In accordance with yet another aspect of the invention there is provided, a method of displaying product information to viewers. The method includes associating product information data with product identification tags, which are further associated with products for sale. The method further includes assigning a unique prospect identifier code to each viewer and furnishing each viewer with a handheld device comprising a display terminal, a processor, memory, an identification tag reader, and software. The method further includes displaying the associated product information data in response to one of the product identification tags being read or scanned by the identification tag reader. The method also involves collecting and storing preference data about each viewer using the handheld device and its software.

In accordance with yet another aspect of the invention there is provided, a method of collecting data about prospects. The method includes associating product information data with product identification tags, which are further associated with products for sale. The method further includes assigning a unique prospect identifier code to each prospect and furnishing each prospect with a handheld device comprising an identification tag reader. The method further includes displaying product information data associated with a given tag in response to the product identification tag being read or scanned by the identification tag reader. The method also involves collecting preference data about each prospect using the handheld device and storing the information on a server that is accessible by client computers via a communications network.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIG. 1 is a diagram of a typical showroom equipped with equipment exemplary of embodiments of the present invention;

FIG. 2 is a block diagram showing major components of the handheld device of FIG. 1;

FIG. 3 is a block diagram of multiple linked showrooms providing data to a central server;

FIG. 4 is a flowchart illustrating a typical sequence that take place once a prospective client (“prospect”) walks into a showroom of FIG. 1;

FIG. 5 is a flowchart illustrating a typical sequence performed by the handheld device of FIG. 2;

FIG. 6 is a flowchart illustrating a sequence performed by the content server depicted in FIG. 1;

FIG. 7 is a flowchart illustrating a sequence performed by the local computer depicted in FIG. 1;

FIG. 8 is a flowchart illustrating a sequence performed by the software running on the central server depicted in FIG. 3; and

FIG. 9 is a subset of an entity-relationship diagram for an exemplary data model used in the design of software depicted in FIG. 8.

### DETAILED DESCRIPTION

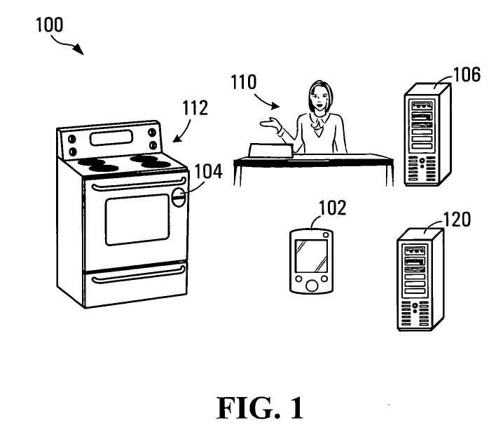

FIG. 1 illustrates a showroom 100 where methods and devices exemplary of embodiments of the present invention may be used. Showroom 100 may be a model home, shown with sample fixtures and appliances or a décor centre that a builder or vendor uses to show options for homebuyers or homeowners renovating their homes. Specifically, a handheld computing device 102, identification tags 104 and a local computer 106 exemplary of embodiments of the present invention are shown in FIG. 1. Handheld device 102, identification tags 104 and local computer 106 are typically located in a showroom 100 where identification tags 104 are prominently displayed. Tags 104 may, for example, be attached to fixtures or appliances 112. Tags 104 may also be associated with a room, or group of rooms, floor plan or other feature that a builder or vendor may wish to highlight.

An optional content server 120 may provide multimedia content for viewing at device 102. Content server 120 and local computer 106 may be the same machine. Software running on content server 120 can be loaded onto local computer 106 thereby eliminating the need for a separate computer to act as a content server.

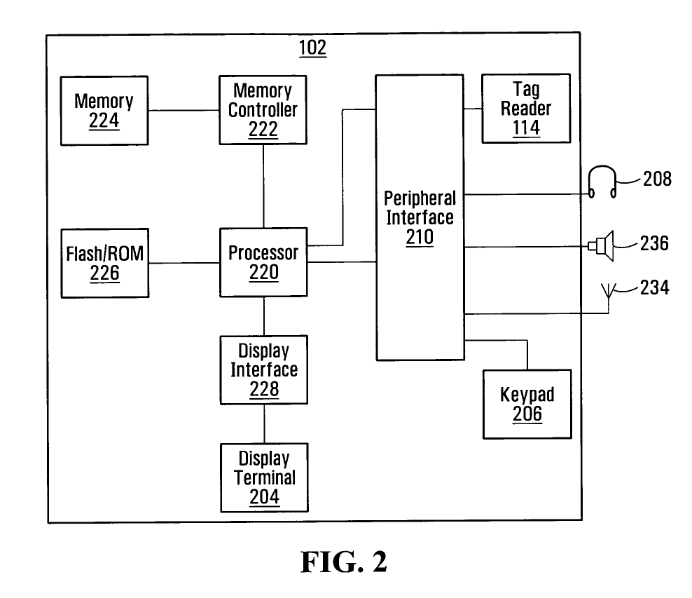

Handheld device 102 is further illustrated in FIG. 2. Handheld device 102 includes a processor 220, memory 224 managed through memory controller 222, a display 204 and tag reading device 114 attached via input interface 210. Handheld device 102 also includes a data entry interface 206 such as a keypad, and a battery. Handheld device 102 is loaded with exemplary software. Handheld device 102 may be one of the many commercially available personal digital assistants (PDA) such as an iPAQ pocket PC from Hewlett Packard, a BlackBerry handset from RIM Ltd. or the Tungsten handheld series from PalmOne Inc., modified to operate in manners exemplary of embodiments of the present invention. Data entry terminal 206 and display terminal 204 may be combined into the same physical element as in the case of a touch screen interface. Data entry interface 206 may be one or more of a keypad, a touch pad, a pointing stick or a mouse. Handheld device 102 may optionally include a headset 208 for listening to the audio component of presentations; and may optionally have speakers 236. Further, non-volatile memory 226 may be a flash memory or an internal hard drive and is used to store the operating system, custom application software and collected data. An optional antenna 234 is also included for the purpose of communicating with either local computer 106 or content server 120 using a wireless data channel such as a Bluetooth, IEEE 802.11 or similar channel.

Tag reader 114 may be any device capable of reading identification tag 104, converting the tag's identification code to electrical signals and presenting the signals to peripheral input interface 210. Tag reader 114 will be complementary to tags 104. Examples of tag readers include a proximity scanner, an RFID reader, a barcode scanner or an optical scanner. Optical scanner devices, capable of converting human readable alphanumeric tags into their equivalent electrical representation in computing devices, are well known. These include pen scanners that can automatically feed a word processor or a spreadsheet program running on device 102, with the alphanumeric information on tags that are scanned.

Identification tags 104 are readable by tag reader 114. Each tag is associated with a product or feature, and each product has product information data suitable for presentation, associated with it. Reading a tag using tag reader 114 causes the software on handheld device 102 to display the product information associated with the tag, on display 204. Identification tags 104 may, for example, be barcodes or other optically discernible patterns that are manually scanned by tag reader 114, RFID tags, radio transmitters, or the like. If the tags are barcodes, then the corresponding suitable tag reader 114 is a barcode scanner. Other suitable identification tags 104 and complementary tag readers 114 will be known to those of ordinary skill. Software on handheld device 102 includes an operating system, including a graphical user interface. The software further includes conventional networking components, supporting known network protocols, such as the TCP/IP protocol. The software further includes an end-user software component that includes a viewer that may be used to view content such as text, graphics, photographs and other interactive multimedia. This viewer is used to interact with the user and present a multimedia presentation. The content includes product information on items of interest such as fixtures, appliances, tiles and others. The content may also show various alternative attributes of the items. The viewer may for example, be an HTML browser. The content may accordingly be arranged as a series of linked data organized in a suitable markup language such as HTML pages. The end-user software further collects data representative of user interaction such as presentations viewed, user input indicating preferences and the like, for storage on local storage 226. The software is also used to upload the stored data representative of user interaction, to a server interconnected computer 106.

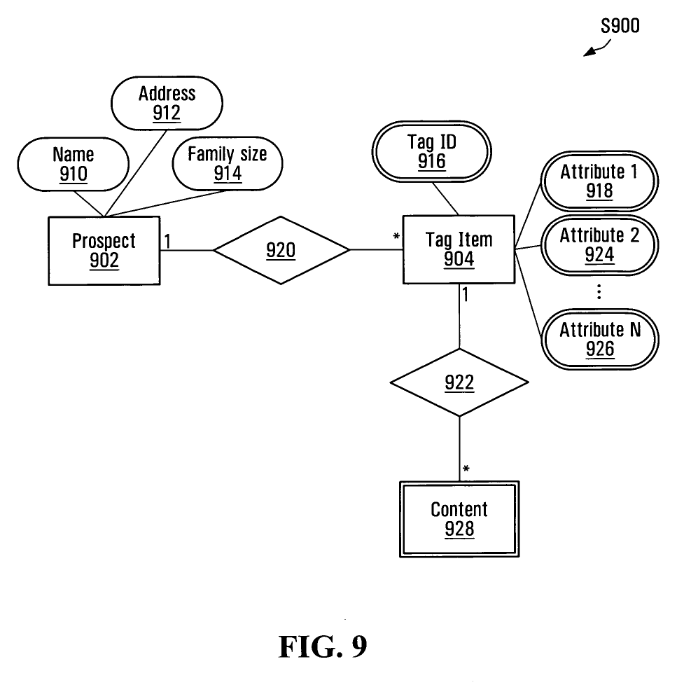

An exemplary data model employed by the end-user software is illustrated in FIG. 9. Data model 900 includes entities prospect 902, items 904, presentation content 928, and their relationships 920, 922. The exemplary data model includes a prospect and a collection of items associated with a tag that he or she is interested in. Each item may contain attributes 918, 924, 926 which may include a set of colors, a set of available sizes and a set of textures. The content may use, for example, images or videos of an entity (house, room, appliance, etc associated with a tag) in preferred combinations of attributes of each entity and render the simulated appearance on the display terminal 204 of device 102. Thus a room can be shown with preferred wall colors, tiles and an optional wall unit. An appliance may be shown in a preferred make, style and size in its preferred location in a given room such as a fridge in a kitchen.

The end-user viewer, in combination with the content provides the ability to select various combinations of the attributes of each room, fixture or appliance so that a user can construct each room in his or her preferred favorite wall color, ceiling, appliance models, tiles, counter-tops and the like. The user may be shopping for an entire house, a specific item such as an appliance or a wall unit, or a service such as those offered by a contractor to renovate a kitchen or bathroom. The user may select say an appliance and construct a preferred sample using available brands, sizes and colors. The user interface employed by the software may be a context menu or dropdown list on an image. The physical data entry interface 206 may be a keypad, a touch pad, a pointing stick or a mouse. The user may also optionally indicate his or her preferred color, preferred brand; counter-top-finishing etc. which would be stored in a central data repository and later retrieved.

Not all the available attributes of each entity are required to exist on device 102. The end-user software can download the information as needed. The preference data are stored and retrieved as needed. Database tables are constructed to represent such a data model using well-known database design techniques for mapping data models to relational database tables. The end-user software preferably records all items viewed. The exemplary software also retains a record of alternate attributes such as color and size of each item that the prospect was viewing. The items viewed and the alternative attributes examined by the prospect would serve as basic preference data for the prospect. Additional preference information by way of an electronic questionnaire or direct text entry or selection from a menu by the user can also be stored to gather a richer set of data about a prospect's tastes and preferences. The questions are designed to understand, prioritize and rank the preferences of the prospect in order to allocate appropriate marketing resources. If a prospect is interested in a particular floor plan or specific lot that is suddenly in demand for instance, he or she could be contacted and informed that supply is running out fast. The questions are also designed to gather data that allow builders or other vendor to tailor marketing of the community in which houses or condos are built, and identify surrounding amenities that the prospect is likely to appreciate. As will be detailed later, part of the data collected would be also used to recreate the user experience at the showroom, when viewing the stored data remotely via the Internet.

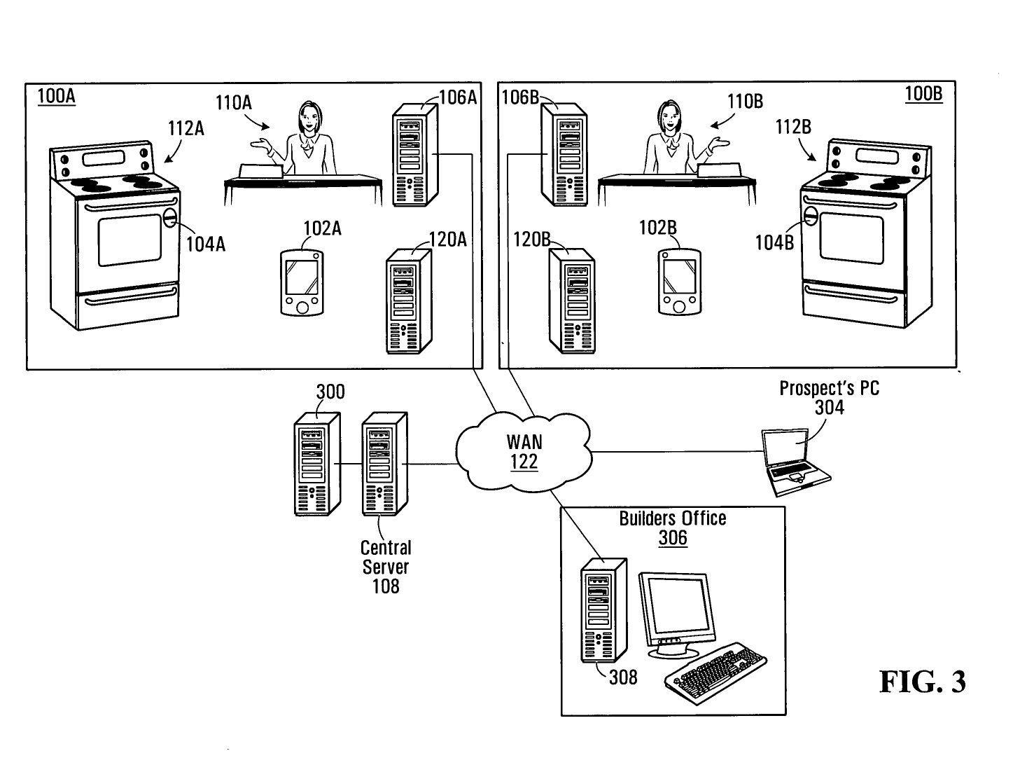

Local computer 106, depicted in FIG. 1 may be a generic personal computer, a laptop, a workstation, or preferably a server class machine with sufficient data storage space and memory to host suitable database software. The database will be used for storing marketing data that would be uploaded from the handheld devices from time to time. Each of local computer 106 and handheld device 102 thus include a data communication interface for uploading or downloading data to and/or from the other device. The data communication interface may be a wired link such as a USB connection or a wireless link. Local computer 106 typically resides on a communications network such as the Internet and may optionally have a web-server software installed. Thus, local computer 106 can be a web server from which aggregated data collected from each device 102 can be accessed using a computing device equipped with a network card and a web browser. Alternately, as shown in FIG. 3, a dedicated external central server computer 108 may be used. Central server 108 is used as both a central data repository and also as a web-sever to provide web-based access to aggregated data from several handheld devices.

Data uploaded from handheld device 102 is stored in a database hosted at local computer 106. Data from each device 102 is correlated to a prospect id assigned to the prospect (i.e., user) using device 102. The database software here may be a relational database management system (RDBMS).

FIG. 3 depicts a wide area network such as the Internet 122, interconnecting local computers 106A and 106B (of the form of local computer 106 of FIG. 1) in showrooms 100A and 100B, respectively; a central server 108, computers 308 at premises 306 and a prospect's home computer 304. Central server 108 may include a number of physical servers. Typically a separate server is used to host the web server software, and a database server 300 hosts the master database. Central server 108 stores data collected using handheld devices 102A, 102B on a database hosted on its database server computer 300. Common web-server software packages include Apache Web Server that runs on UNIX and Linux operating systems; and the Internet Information Services (IIS) that runs on the Windows family of server operating systems. The web server software accesses database server 300 when data is needed for display or updating purposes. Both web server software and database server software may be hosted on the same physical server or workstation, or several servers may be clustered together to share the task of running the web server and database server using load-balancing software.

Central server 108 is programmed with appropriate server side software that allows prospects, after appropriate authentication, to view a record of model suites, houses, fixtures, appliances, and showrooms they have visited, and other relevant data using suitable client side software, preferably a web browser. In addition, the software may also allow the display of showrooms visited and particular items of interest in the prospect's preferred colors and finishing materials as a visual reminder. Prospects are able to save their preferences whenever they wish to adjust their budget or tastes.

Prospects can access central server 108 through network 122 using a simple personal computer or laptop computer 304 equipped with a suitable network interface. Similarly, builders or vendors have access to this valuable aggregated data in server 108 from their premises 306 via any computer 308 with access to network 122.

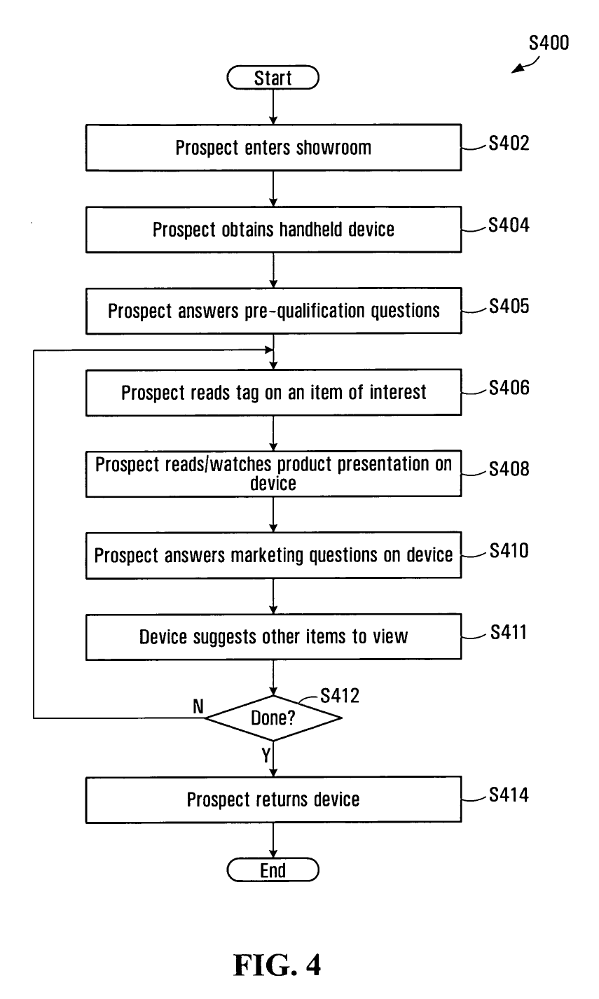

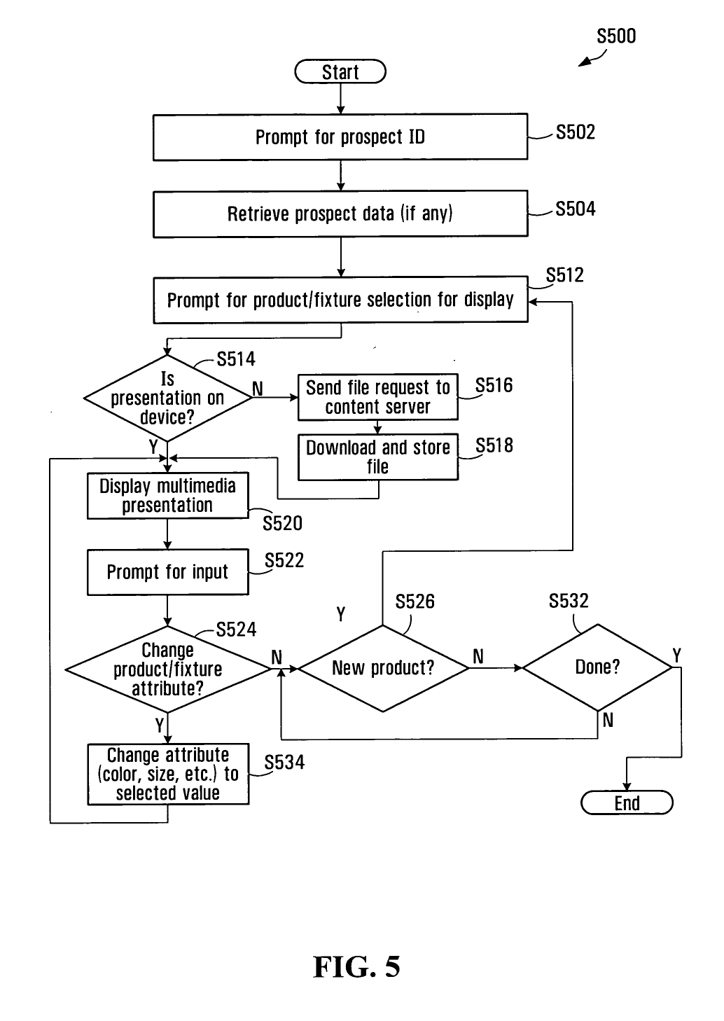

A typical sequence of actions by a prospect that takes place in a showroom is illustrated using flowchart S400 in FIG. 4. Steps performed by computing device 102, content server 120, local computer 106, and central server 108 are illustrated in FIGS. 5-8.

As illustrated, a prospective client walks in to a showroom or a décor center such as showroom 100 depicted in FIG. 1; registers with a greeter 110 and obtains a handheld device 102 in step S402 (FIG. 4). Greeter 110 may ask for a piece of identification such as a driver's license, which would be returned to the prospect upon returning handheld device 102. The prospect may be requested to provide pre-qualification data related to demographics and marketing to establish a preliminary profile before being assigned a prospect id for the first time. The prospect's identifier (prospect id) is programmed into the handheld and the device is given to the prospect (step S404). Alternately, the pre-qualification questionnaire may be filled in directly on the handheld device after the prospect id is assigned and programmed onto the device (step S405). There are many ways of assigning the prospect id to a prospective customer. The prospect may even be assigned a prospect id prior to arriving at the showroom by, for example, pre-registering using the web or via telephone.

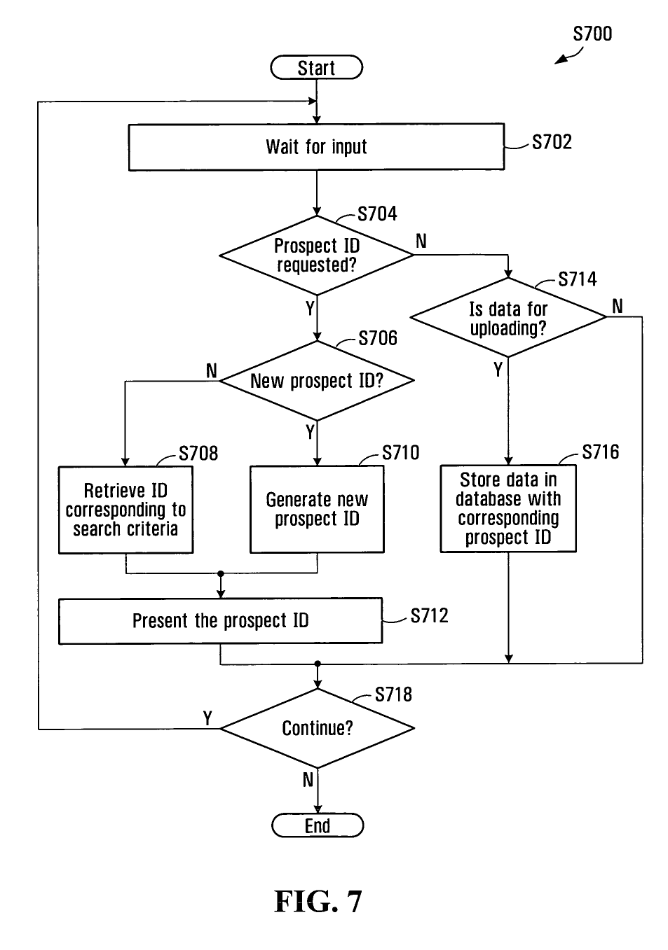

An exemplary process of determining the prospect id to program into handheld 102 is shown as part of flowchart S700 in FIG. 7. In step S704 software on local computer 106 determines if input is a request for a prospect id. If so, step S706 determines if a new prospect id is requested. If the request is for an existing identifier, the server is searched and the id corresponding to a given prospect's search criteria such as a name, an address or a driver's license is returned (step S708). In the case of a request for a new prospect id, in step S710, a new number is generated. Different showrooms should be assigned a unique range of ids that they are allowed to assign to ensure that each prospect has a unique identifier across all showrooms. When data is aggregated later, any duplicate assignments will create data consistency problems.

The prospect with a handheld 102 associated with his or her unique prospect id now walks about the showroom looking at any items of interest on display. As the prospect sees a particular area, fixture or accessory, etc. of interest 112, he or she uses identification tag reader 114 of device 102 to read a tag 104 in proximity to the area, fixture, accessory, etc. of interest (step S406). The user may be given suggestions as to which items to view (tags to read) based on the preliminary profile that was prepared in step S404. In response to reading the tag, software at device 102 initiates the display of a multimedia product presentation associated with the product of interest, on handheld device 102 which is viewed by the prospect in step S408. As detailed, below, the presentation may be a multimedia demonstration including digital video, audio, graphics and text. The product information data may also include code or code portion that executes on the handheld device, such as a Java applet that executes inside a browser. The code may for example, present an electronic questionnaire or menu to interact with the user to gather data, control the flow of multimedia presentation or the like.

The operational steps of the software on the handheld device are depicted in a flowchart S500 shown in FIG. 5. The software waits for the prospect identifier to be supplied in step S502. Once the prospect id is supplied and stored, any prospect data that was stored previously is retrieved in step S504. The software proceeds to wait for a product presentation request (step S512) which may be made by scanning a product identification tag 114. Once tag reader 114 has read a tag 104, the software determines if the product presentation file associated with the product of interest resides in local storage 226 on device 102 in step S516. If so, the software displays the contents of the file in step S520. If the file is not on local storage however, then a request is made to content server 120 and the file is retrieved or downloaded first in steps S516 and S518. In steps S522-S534, the user is allowed to change different attributes such as color and size of fixtures and appliances or even change the room or house of interest to view his or her preferences in different combinations interactively.

The presentation file may be stored in handheld device 102 itself and when desired, displayed on display terminal 204 by processor 220 using display controller 228. In this case, a concordance is maintained by software running on the handheld device, which matches each fixture's tag id with a stored presentation data, such as a digital multimedia file associated with the respective fixture. Depending on the total number of items on display in the showroom and the length of presentations, pre-storing the presentations locally may require a large amount of storage space on the handheld device. Altematively, software on handheld device 102 can be used to access content server 120, preferably using antenna 234, to pull or download presentation content associated with a desired item for display on handheld device 102. Server 120 may thus provide presentation content onto the handheld client upon request, in typical client/server architecture. New presentation content need only be pulled from a content server 120 only when content associated with a desired item is not already on device 102.

Conveniently, the presentation may be programmed by a builder, vendor or operator as a showroom/décor center is established. For example, a component of software at content server 120 or local computer 106 may allow the builder or vendor to associate specific tags with specific content. This may be accomplished for example, by associating HTML links that identify HTML pages containing relevant information with RFID tags using handheld device 102, as the RFID tags are placed in a décor center. Pages may be programmed using a conventional HTML programming software hosted at local computer 106, or elsewhere.

The presentation file may include, but is not limited to, a video presentation of the item of interest such as for example an appliance, a list of the colors available for the item, list of different brands and corresponding price ranges, list of available sizes and finishing materials.

Once the presentation is at device 102 (or as it is downloaded), it is replayed and provides the user with further information about the area, etc. with the tag 104 that initiated the multimedia display. As already discussed, the multimedia presentation may be interactive, allowing the user to query additional information and options about the area, etc. of interest. The presentation may also include a questionnaire of preferences to be completed by the prospect. It preferably also includes many interactive features showing different options. For example, the presentation may allow presentation of multiple optional fixtures appliances, etc. in different colors and textures to help prospects better visualize available alternatives.

Data entry is easily facilitated by a keypad 206 or touch-screen interface on the handheld device, and processor 220 with its associated operating system and custom application software for collecting and storing supplied data as well as for generally interacting with the user. Keypad 206 is attached to device 102 via peripheral input interface 210 as shown in FIG. 2.

Data representative of user interaction may be stored at device 102 in step S516. Thus, at the conclusion of each presentation, device 102 has stored data representative of the areas viewed, and the level of detail requested by the user.

The stored data is sufficiently detailed to recreate a history of the user's journey and actions in the showrooms. The data includes, model houses selected, rooms viewed, colors of walls selected, an optional preferred attribute that the user indicates such as wall color, or type of wood for wall unit, alternative options viewed such as different tiles selected and viewed for kitchen floor and many other similar details. A record of these would enable the user to experience a virtual tour of where (which model homes) he or she has been to and what selections were made. In addition, the user may optionally indicate favorite attribute such as wall color of the living room. This data is stored can later be used to display the living room in the prospect's preferred mode. The data is also useful to the builders and vendors in guiding their setup of décor centers.

At the end of all product presentations, the prospect may be prompted to enter his or her impressions about the displayed items of interest (step S410). This may include questions regarding the importance of the fixture or the model house just displayed, the price range contemplated, time frame for purchasing and other relevant information related to the decision to buy. The user may also be prompted to answer a series of demographics related questions for general marketing. Handheld device 102 then stores the answers to these questions in its storage. Device 102 may also suggest other items to view (step S411) that are likely to be of interest to the prospect based partly on answers to the pre-qualification questions.

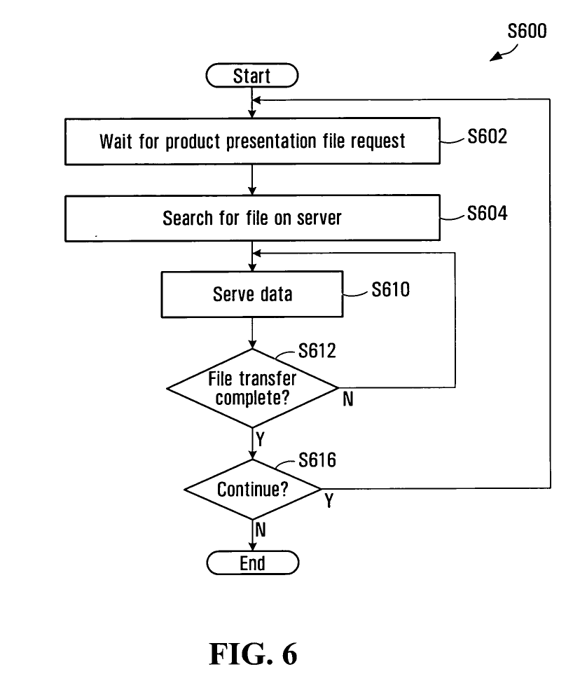

A flowchart S600 is shown in FIG. 6 depicts the operations of the hardware and software of content server 120 of FIG. 1. The software waits for a product presentation file request in step S602. Once a request for a product presentation file is received, it proceeds to check for the file on the server machine (step S604). If a file associated with the requested product id is found, then the data is served as a series of data packets to the client (steps S610, S612) until the whole file is transferred. Otherwise, an indication is sent to the client software (i.e., software running on the handheld) that the file is not on the content server. The process then continues back at step S602 unless stopped in step S616.

After looking at all items of interest in the showroom on a given session, and entering data prompted by custom software on the device, the prospect returns the handheld device 102 back to the greeter 110 (step S414).

Collected data is uploaded onto local computer 106 as shown in FIG. 7. Flowchart S700 shows the operation of local computer 106. The software on local computer 106 waits for input in step S702. If the input data is customer preference data to be uploaded to local computer 106 (step S714), then the data is stored in the rows of appropriate tables of the database associated with the current prospect id (step S716) and the process starts again (step S718). This step could be as simple as copying a database file maintained locally on the device, to a hard disk on the local computer 106. This synchronization can be accomplished by a wireless link or using a wired alterative, for example a USB interface from the handheld device to local computer 106. Altemately a serial interface or any other suitable data communication interface may be used to upload the data. Device 102 uploads all the required data collected during the presentations to local computer 106. Afterwards, the device's locally stored data can be erased so that it can be used anew by the next prospect. A summarized print-out of the tour can be emailed or printed and given to the prospect upon returning the handheld device 102 to the greeter. A username and password may also be provided to the prospect for viewing his or her selections online at later time.

Local computer 106 may periodically send information to a central server 108. If, as illustrated in FIG. 3, a number of showrooms participate in a wide area network such as the Internet 112 to aggregate data, the information from various participating showrooms can be consolidated and stored on central server 108. Any new information associated with a prospect would be added to the prospect's profile and the master database is updated. The information to be uploaded is preferably sent via the network (Internet) 122 itself or may be saved on a medium such as a compact disk (CD) and later uploaded to central server 108 using a peripheral device such as a CD-ROM drive.

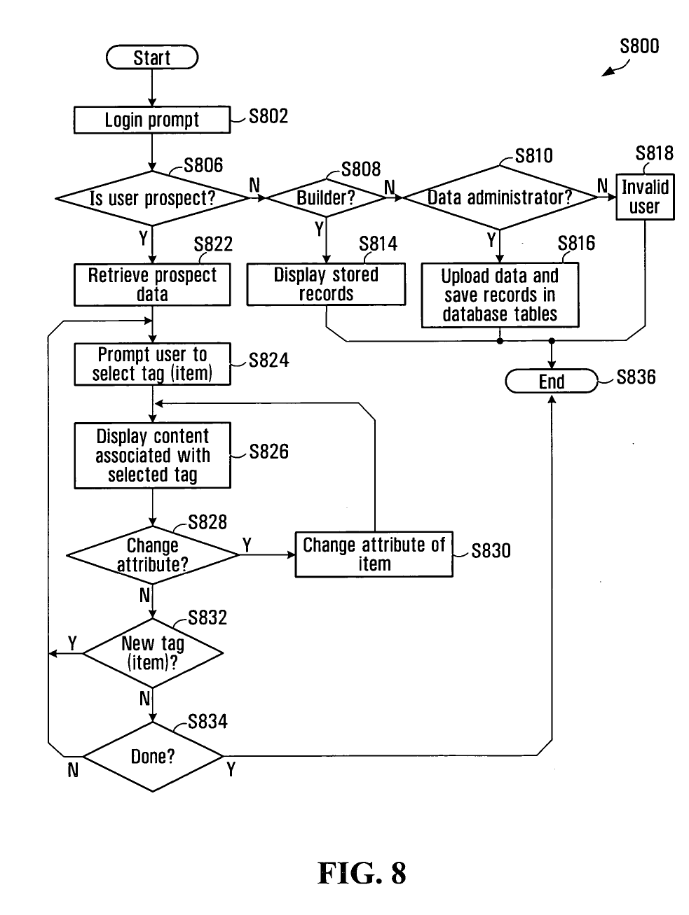

The operation of the central server 108 is depicted in FIG. 8. In conjunction with the web server software, central server 108 runs custom server-side software module as depicted in flowchart S800 in FIG. 8. In step S802, the user is prompted for a username and password and authenticated. Prospects having known usernames and passwords may view data or presentations based data previously collected from that prospect at various showrooms. It may also allow new data to be entered or permit changing of data already entered such as preferences of styles, colors and price range.

When a prospect logs into central server 108, after authentication in steps S802 and S806, the data associated with the prospect is retrieved in step S822. The prospect is then prompted to select an item associated with a tag such as an appliance for viewing in step S824. After the selected item is displayed in a default format and style in step S826, the user may change the attributes in steps S828 and S830. The user may for instance alter some attribute of a house such as outer color or roofing material and view the house again. Alternately, the user may decide to select a room and after viewing the room may proceed to change attributes of the selected room. A builder or vendor who logs in (S802, S808), may view stored records about any prospect (S814). A data administrator who may be a greeter at a showroom for example, may login and upload (S810, S816) data from returned handheld devices 102 on to the server 108.

In the depicted embodiment, data may be presented in the same order and format as was viewed by the prospect at site(s) 100. All the capabilities of the software on handheld device 102 may be present on the software on central server 108, and vice versa. Features of the software are also preferably are accessible via a web browser. This allows users to replay presentations based on preference data stored while at different showrooms, from a location of their choice such as their current residence. It also provides prospects with enough interactivity to simulate different scenarios as if they were in the showrooms using the handheld devices. Users can vary the various attributes of the rooms by selecting different colors, tiles, fixtures and appliances via software (rather than scanning tags) and have an interactive session in redesigning their house. Any new data provided by the prospect may be saved.

The information stored on central server 108, from handheld devices 102 encompasses all the data needed to essentially create a virtual tour of the prospect's actions while in the showroom. The data is stored in the appropriate tables of a database, preferably constructed in accordance with the data model of FIG. 9. The database software may be any conventional database management software including object-oriented and relational database management systems (RDBMS) that are in wide use as data repositories for web-sites. Preferably central server 108 shows the model home of interest starting with the prospect's saved preferred attributes. Software on central server 108 also indicates the various attributes that were available such as colors and sizes.

Administrators (such as builders or vendors) are normally allowed to view data from all prospects. This allows them access (step S814) to prospect data from each showroom that participates in the network 122. Several layers of access privileges can be defined for various groups of users and data access will be restricted accordingly. The use of a web interface (HTTP protocol) assures that a standard and plafform-independent protocol is used to access the data without requiring proprietary hardware or software. If the connection to the central server was made to upload data as in step S810 and S816, then data is uploaded and the software updates relevant database tables on the master database.

As may now be appreciated, a group of builders or vendors cooperating to establish a common information repository and marketing data collection network, may use data at server 108 to track prospects' preferences as prospects visit various showrooms operated by the builders and vendors, to create a more complete profile for targeted marketing. The resulting information collection and sharing network would likely be much better than any marketing data collection scheme that any one individual builder or vendor can establish alone. A single unique prospect identifier would conveniently be used across all participating showrooms to track a prospect and create a unified and more complete profile.

This system of networked data collection and access would allow builders to track changing consumer tastes and shifting sentiments, and market to prospects accordingly. It also helps shape decisions on future building projects by better alerting them to subtle trends. The prospect profile data thus accomplished would be more complete since data is being aggregated from various showrooms from different participating builders. This aggregated data would clearly be a more reliable indicator of demand trends than spotty data collected in a single visit at a given model suite or showroom.

Moreover, the database of prospects also represents qualified leads that can be marketed to very efficiently by for example sending them an electronic mail notification whenever a new condominium or house is available on the market or whenever there has been a price reduction. Vendors of big-ticket items such as large appliance retailers or car dealers can also profit by making use of this database of prospects in their marketing campaigns and incentive offerings.

Among the many alternative embodiments of the present invention is a modified prospect id assignment procedure where all members of a family may use a single prospect id. This allows each member of a family to visit different rooms in a given model home or even visit different model homes at different locations simultaneously and have their preference data aggregated in a single profile.

In another alternative implementation, clients may be able to show up at a model home or showroom with their own a generic handheld device such as their personal digital assistant (PDA). Clients would be provided with a suitable tag reader that preferably uses a standard interface such as a USB interface, after they register with the greeter. The software for the handheld can be downloaded onto their PDA at the site using a wired or wireless interface. In addition to the software, data such as available homes, colors and sizes and optional features for that particular site can be loaded. This has the advantage of making the data available on the PDA for the prospect so that an Internet connection is not necessary to review the selections made.

Of course, the above described embodiments are intended to be illustrative only and in no way limiting. The described embodiments of carrying out the invention are susceptible to many modifications of form, arrangement of parts, details and order of operation. The invention, rather, is intended to encompass all such modification within its scope, as defined by the claims.

What is claimed is:

1. A handheld device for displaying product information to a user, said handheld device comprising, a processor, processor readable memory, a display, and a product identification tag reader capable of reading data encoded onto a plurality of product identification tags, each of said plurality of product identification tags associated with one of a plurality of products available for purchase by said user,
said processor readable memory storing processor executable instructions adapting said handheld device to, in response to said identification tag reader reading one of said product identification tags, display on said display, product information data associated with said one of said product identification tags; and
said handheld device stores user information reflecting for which of said plurality of products, said handheld device has displayed product information data for said user.

2. The handheld device of claim 1, wherein said user information comprises attributes of said plurality of products that reflect individual preferences of said user.

3. The handheld device of claim 1, wherein said processor executable instructions further adapt said handheld device to upload said user information from said handheld device onto a server computer.

4. The handheld device of claim 1, wherein said processor executable instructions further adapt said handheld device to interactively display modified versions of said product information data associated with one of said products, in response to requests from said user.

5. The handheld device of claim 3, further comprising a data entry interface wherein said requests from said user are communicated to said handheld device using said data entry interface.

6. The handheld device of claim 5, wherein said data entry interface comprises a keypad.

7. The handheld device of claim 1 wherein said handheld device comprises a wireless interface.

8. The handheld device of claim 1 wherein said tag reader comprises a barcode scanner.

9. The handheld device of claim 1 wherein said tag reader is capable of reading human readable alphanumeric codes.

10. The handheld device of claim 1 wherein said tag reader is radio frequency identification (RFID) tag reader.

11. The handheld device of claim 1 wherein said product information data is a multimedia presentation.

12. The handheld device of claim 1 wherein said product information data comprises data organized in a markup language.

13. The handheld device of claim 1 wherein said product information data comprises executable code.

14. The handheld device of claim 13 wherein said product information data comprises a java applet.

15. The handheld device of claim 1 wherein said processor executable instructions adapt said handheld device to download said product information data from a content server onto said handheld device for display.

16. A method of displaying product information to a user, said method comprising,
a) associating product information data with each of a plurality of product identification tags and further associating each of said product identification tags with one of a plurality of products or services;
b) assigning a unique prospect identifier to said user;
c) furnishing said user with a handheld device comprising a processor, processor readable memory, a display, and a product identification tag reader capable of reading data encoded onto said plurality of product identification tags;
d) displaying on said display, said associated product information data in response to said identification tag reader reading one of said product identification tags; and
e) storing information reflecting, for which of said plurality of products or services, said handheld device has displayed product information data for said user.

17. The method of claim 16 wherein said storing updates a central data repository.

18. The method of claim 17 wherein said central data repository is a database installed on a computer.

19. The method of claim 18 wherein said central data repository is accessible by a computing device using a communications network.

20. The method of claim 18 wherein said user is a prospective homebuyer.

21. The method of claim 20 wherein said product information data comprises information about home fixtures and appliances.

22. A computing arrangement comprising a central server; a plurality of client computers; and a plurality of handheld devices,
said central server comprising a server computer, web-server software, a data repository, and server-side software,
each of said handheld devices comprising, a processor, processor readable memory, a display, a product identification tag reader capable of reading data encoded onto a plurality of product identification tags, and software, wherein said software displays on said display, product information data associated with one of said product identification tags in response to said identification tag reader reading one of said product identification tags; each of said product identification tags is associated with one of a plurality of products; and said software collects information about a user's interest in said products;
wherein said handheld devices store said information about said user's interest in said products on said central server; and
said client computers are operable to access information about said user's interest in said products from said central server by way of a communications network.

23. A method of collecting data about prospects, said method comprising,
a) associating product information data with each of a plurality of product identification tags and further associating each of said product identification tags with one of a plurality of products or services;
b) assigning a unique prospect identifier to each of said prospects;
c) furnishing each of said prospects with a handheld device comprising a product identification tag reader capable of reading data encoded onto said plurality of product identification tags;
d) displaying on said display, said associated product information data in response to said identification tag reader reading one of said product identification tags; and
e) storing in a central server computer, information reflecting,
i) for which of said plurality of products or services, said handheld device has displayed product information data for said prospects; and
ii) preference data as supplied by said prospects
wherein said central server is accessible from client computers operable to communicate with said central server to read said stored information by way of a communications network.

24. The method of claim 23 wherein said stored information is marketing related data.
